(19) United States
(12) Patent Application Publication
(10) Pub. No.: US 2009/0228155 A1
(43) Pub. Date: Sep. 10, 2009

(54) DISPLAY AND MANAGEMENT OF EVENTS IN TRANSPORT REFRIGERATION UNITS

(76) Inventors: Timothy P. Slifkin, Morristown, NJ (US); Thomas A. Robinson, Mendham, NJ (US); Venkateswaran Karuppanan, Morristown, NJ (US)

Correspondence Address: LEO STANGER, 382 SPRINGFIELD AVENUE, SUMMIT, NJ, 07901, US

(21) Appl. No.: 12/269,969

(22) Filed: Nov. 13, 2008

Related U.S. Application Data
(60) Provisional application No. 60/989,920, filed on Nov. 23, 2007.

(51) Int. Cl. G05D 23/00

(52) U.S. Cl. 700/299

(57) ABSTRACT

The status of a transport refrigeration unit and the load therein is established on a real time and batch time basis by continuously transmitting the cargo temperature or reefer return temperature, and determining conditions such as loading and unloading, open doors, waiting times, etc. This allows apportioning costs between the operator of the transport and the consignee of the cargo.

### RELATED APPLICATIONS

Applicants claim the benefit of application Ser. No. 60/989,920 filed 23 Nov. 2007.

### FIELD OF THE INVENTION

This invention relates to the display and management of events in a transport refrigeration unit, and particularly to imputing assessorial charges.

### BACKGROUND OF THE INVENTION

Transport refrigeration units are used to transport and maintain the temperature control environment for temperature sensitive fresh and frozen food products, life-science products and temperature sensitive durable goods. Because temperature controlled shipments require special equipment, periodic maintenance, fuel or energy sources, an evaluation of the environmental conditions, consideration of the use of multi-compartments and special attention to the commodity's environment, the transport cycle for refrigerated shipments is more complex than those of ordinary dry-container shipments. It is desirable to permits freight operators to enforce equipment use fees that are generally applied in the transport refrigeration industry. These use fees, called assessorial charges, involve a third party's use of the operators' equipment and/or fuel, and may involve reimbursement of operators' unexpected costs. For instance, should an transport refrigeration operator drop off a reefer trailer for unloading at a customer facility, they may create an expected time frame that the unit may stay in the staging area prior to unloading for that specific facility. Operations often involve dwell times in the staging area and other delays and losses which have been difficult to assess.

An object of this invention is to measure specific operations, which may be applied to the assessorial portion of their contract.

### SUMMARY OF EMBODIMENTS OF THE INVENTION

According to an embodiment of the invention, this object is achieved by measuring and wirelessly transmitting special events, such as temperatures and fuel states during a transport cycle, and attributing assessorial portions on the basis of the measured events.

### BRIEF DESCRIPTION OF THE DRAWINGS

FIG. 1 is a diagrammatic illustration of a refrigeration transport embodying features of the invention.

FIG. 2 is a graph illustrating changes in conditions sensed by the system embodying the invention.

FIG. 3 is a graph illustrating changes in fuel sensed by the system embodying the invention.

### DETAILED DESCRIPTION OF PREFERRED EMBODIMENTS

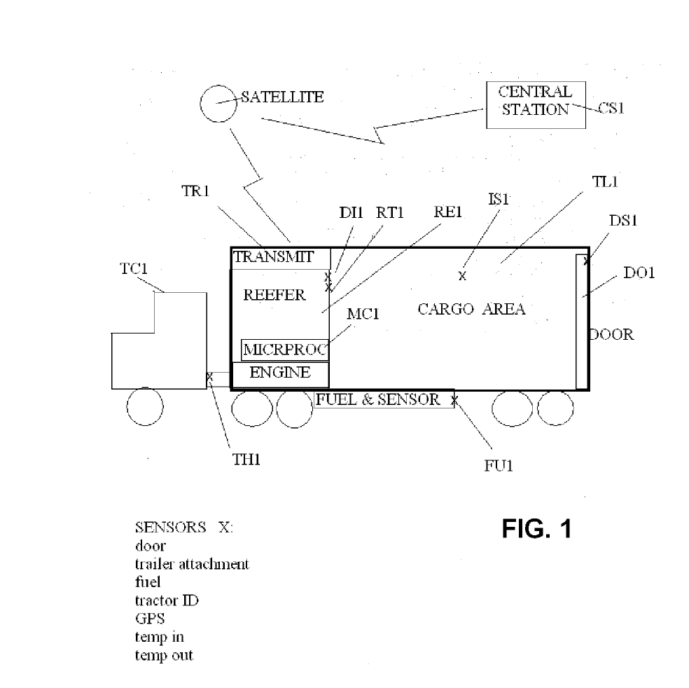

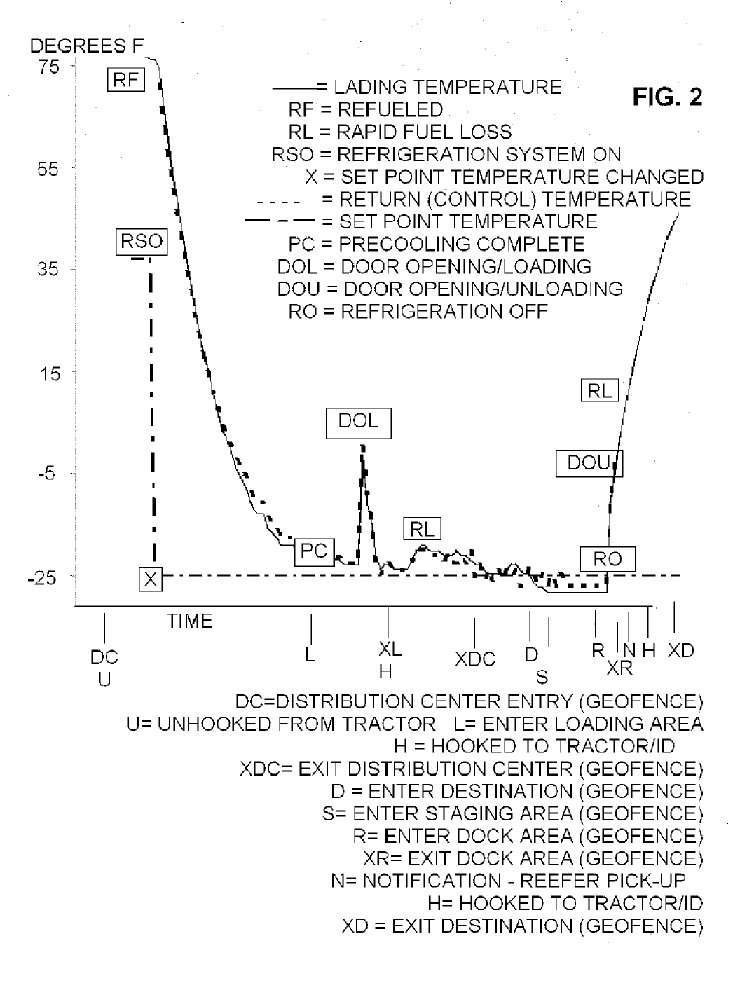

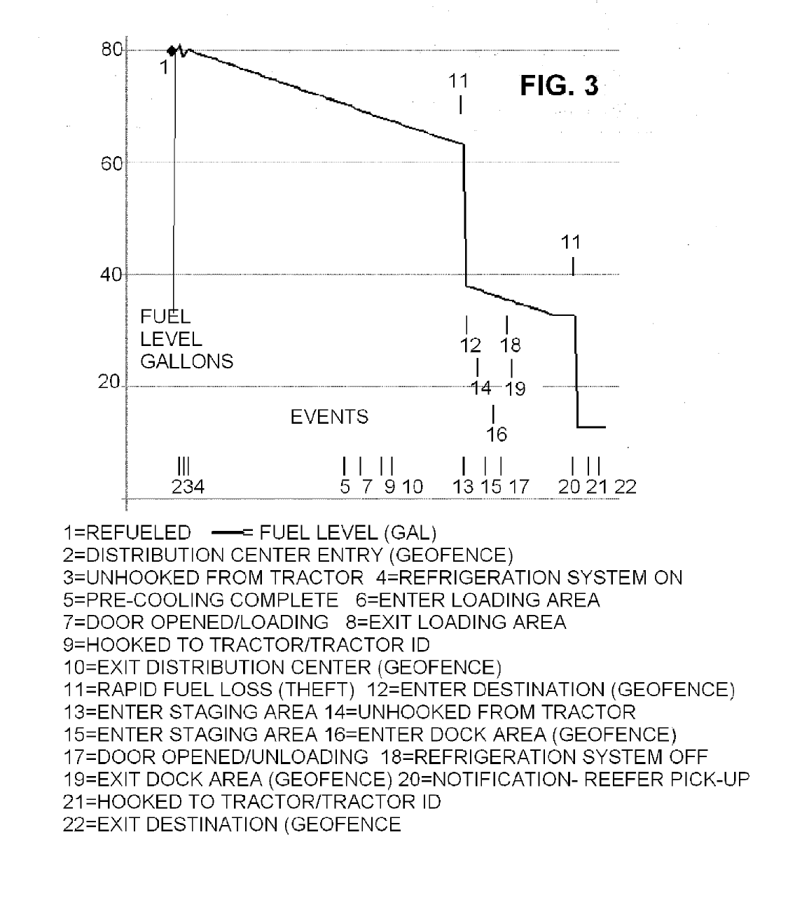

In FIG. 1, a tractor TC1 hauls a trailer TL1 that carries a reefer (refrigeration unit) RE1 for cooling a cargo area CA1 within the trailer. An engine EN1 in the reefer RE1 powers the reefer and receives fuel from a fuel tank FT1, which contains a fuel sensor FU1, carried below the trailer TL1. A trailer door TD1 with a door sensor DS1 provides access to the cargo area CA1. Sensors are illustrated by X. A transmitter system TR1 receives the outputs of the sensors DI1, RT1, FU1, TA1, DS1, a GPS unit GP1, and any other sensors used on the system, and transmits the outputs to a satellite SA1. The latter, in turn transmits the signals to a central station CS1 for management and recording. The central station CS1 records the information displays the information as graphs shown in FIG. 2 and FIG. 3.

The embodiment of the invention produces an operational display that constitutes a graphical method to convey when the important operational events occurred, and the duration of specific refrigeration operational states during a refrigerated transport cycle. The display permits management of resources.

The display and management are important because transport refrigeration units are used to transport and maintain the temperature control environment for temperature sensitive fresh and frozen food products, life-science products and temperature sensitive durable goods. The embodiments of the invention enable a carrier to offer the special conditions that temperature controlled shipments require. Such conditions include, for example, special equipment, periodic maintenance, fuel or energy sources, an evaluation of the environmental conditions, consideration of the use of multi-compartments and special attention to the commodity's environment. The embodiments provide for the more complex the transport cycle for refrigerated shipments than needed for ordinary dry-container shipments. The embodiment, because it furnishes monitored and data controlled by wireless devices using gps, refrigerated containers, create unique, special information particular to refrigerated shipments. As a result of this behavior, the invention imparts management and graphical tools to optimize refrigerated transport shipments, by monitoring the special freight and refrigeration events associated with transport refrigeration units.

The embodiments of the invention utilize the events that can be monitored in real time via wireless communications, and thereby measure specific attributes of the transport refrigeration transport cycle. As various stages of the transport cycle are “bounded” by refrigeration or logistical events, detailed refrigeration “states” are automatically defined and the transport cycle time and quality are measured. The embodiments apply to all aspects of the transport refrigeration units, and includes the monitored event status of auxiliary sensor status, such as fuel, door opened closed, trailer hooked, unhooked, tractor identified and tractor identifying number identified, mileage read, geofences entered or exited, and refrigeration unit moved or is stationary. In addition to the unique elements of refrigeration transport events, events generated by these auxiliary sensors/operations yield a comprehensive understanding of the refrigeration transport delivery cycle. Individual cycle segment measurements may then be summarized and compared so that specific operational standards can be created for each operational segment.

A typical delivery life cycle of a transport refrigeration unit (“reefer”) is shown in FIG. 2. The refrigerated transport unit, namely the trailer TL1 is equipped with a wireless device, the transmitter TR1, which has real time monitoring capability for numerous sensors, possibly including but not limited to gps, refrigeration unit fuel sensor FU1, transport refrigeration units microprocessor readings, local reefer on/off switches, door sensor DO1, tractor hooked sensors TH1, etc.

The wireless device TR1 has local intelligence capability, which allows it to constantly monitor the sensors DI1, Rt1, FU1, TA1, DS1, a GPS unit GP1, and any other sensors used on the system, and evaluate conditions locally on the asset compared to previous conditions, in such a manner to detect specific events. For instance, by comparing gps readings which are made frequently by the wireless device, the system is able to determine if the reefer has moved into or out of a specific gps defined area (geofence). Further, by comparing fuel levels to previous fuel levels and compensating for the error in the sensor, sloshing in the tank and the use of fuel by the reefer, the monitoring device is able to determine when the fuel tank is refueled or when fuel is stolen from the tank (rapid fuel loss). Furthermore, the wireless device is able to distinguish between geofences identified as distribution centers (origin points for trip creation), distribution junctions, and customer locations (destination locations), which allows the wireless device to determine where loading events occur and when unloading events occur. Further, after a transport refrigeration unit, reefer RE1, is switched on, a period of time is necessary to pre-cool the unit suitable to load the asset, namely cargo in the cargo area CA1, and a pre-cooling notification occurs by comparing various temperatures to previous temperatures. Further, by monitoring the control temperature setting on the refrigeration unit microprocessor, as well as any independent temperature probes, the embodiments detect when the door is opened and loading/unloading processes have begun. Because the wireless device is connected by wireless communications to a computer network, or central station CS1 and database, the embodiment of the invention achieve comprehensive transport refrigeration unit monitoring. The wireless device, transmitter TR1, also frequently monitors refrigeration temperatures, including temperatures contained in the reefer microprocessor MC1 including but not limited to set point temperature, discharge or supply temperature, return temperature, remote temperature and ambient temperature, as well as temperatures for multi-compartment reefers. These temperatures are generally readable when the reefer unit is switched on, and sometimes, users of transport refrigeration units, reefer RE1 use remote, independent temperature probes, which measure the temperature of the contents (lading) (cargo) of the transport refrigeration unit while the reefer unit is switched off. Constant monitoring of temperatures and other important aspects such as fuel are monitored, frequently delivered to the network or central station CS1 to provide operational profiles of each shipment.

As shown in FIG. 2 and FIG. 3, a transport refrigeration unit delivery life cycle involves events, such as refueling, entry into a geofence location at a trip origin, unhook from a tractor, transport refrigeration unit on, transport refrigeration set point temperature changed, pre-cooling completed, entry into a loading dock (geofence), door opened (which may be associated with loading at a origin geofence or a loading lock geofence), exit origin facility (geofence), arrive at customer location (geofence), entry into a staging area prior to unloading (geofence), unhooking of the tractor, entry to an unloading dock (geofence), open doors (unloading at a destination geofence), transport refrigeration unit switched off, doors closed, exit the dock area, entry into a staging area (geofence), notification that the unloading has occurred so that the trailer may be utilized, tractor hook, and related functions regarding the subsequent delivery cycle.

In FIG. 2, the transport refrigeration delivery cycle shows various temperature settings on the Y-Axis and time on the X-Axis. Temperature measurements shown in the graph above include actual temperatures, which are delivered in real time or recorded and delivered in batch form via wireless communications. In this case, the temperatures shown are for that of an independent temperature probe IS1, the return control temperature of the reefer microprocessor by sensor RT1, and the set point temperature at 15 minute increments, and the overall time frame involved of the entire operation of the transport delivery cycle shown graphically is approximately 30 hours.

FIG. 2 and FIG. 3 also show events and operational activities in relation to the time/temperature profile of the refrigerated transport cycle. For instance, a refueling event is visible prior to the time the refrigeration system is switched on. Next, entry into an origin geofence (distribution center) is identified at DC. Then, the refrigeration unit is switched on, and the set point temperature is changed (from 37 degrees to −25 degrees) at time X the temperatures for return temperature become visible (because the microprocessor is on and allows the wireless device to read it), and the entire refrigeration unit shows temperatures dropping to the prescribed level. When the refrigeration unit has reached the proper cooled level, the wireless device sends a pre-cooling notification, which allows the operator to know to load the trailer. The real-time notification of this pre-cooling event is very important because (1) the refrigeration unit would be wasting fuel, (2) otherwise be unusable for freight shipments, (3) be incurring engine hours needlessly increasing maintenance costs and (4) generate excessive carbon emissions if the transport refrigeration unit is permitted to consistently idle in this state for long periods of time.

The pre-cooling notification is typically followed by notification that the trailer entered the loading dock area at time L, and that the doors are opened (by virtue of a door sensor or the temperature spike). After loading, the unit exits the loading facility at H, exits the distribution center at XDC and begins its travel to its single or possibly multiple destinations.

By having the wireless device, transmitter TRI, monitor the historical temperature and the temperatures relationship to ambient temperature, this invention makes it feasible to measure when transport refrigeration units are loaded with lading that has not been pre-cooled. This activity places a greater strain on the transport refrigerator operator by burdening them with higher risks of spoilage, higher fuel expenses, higher maintenance costs and greater wasteful emissions.

During its transit, many alarms or events may occur. For instance the refrigeration unit may experience an alarm condition, causing the temperature to rise and requiring immediate intervention. The embodiment shows a rapid fuel loss event, which indicates that a certain amount of fuel was siphoned from the fuel tank. The alarms and events are communicated by wireless communications immediately to the operator, who may take intervening steps to repair the condition or recover the shipment before it spoils.

At destination D, the wireless device provides a notification of the reefer's entry into a customer facility. Similar to the pre-loading sequence, all of the events are graphically shown in reverse order. In this set of circumstances, a driver of a tractor is “dropping the trailer” so that it can be unloaded by the customer, which is frequent practice to improve freight operator's utilization of tractors and refrigerated trailers. Thus, once the tractor is unhooked and delivered to the customers pre-unloading staging areas at S, the trailer is in the possession of the freight operator's customer.

This invention is a useful tool for the freight operator to identify the unloading operations of their customers by examining the wireless communications data and reviewing it on the graphical display. In this instance, the freight operator witnesses when the reefer is taken out of the staging area, when it approaches the loading dock R, when the doors are opened and unloaded, when the refrigeration unit is turned off, and when the refrigeration unit is available to be utilized for the next shipment cycle. Once the refrigeration unit is turned off, return temperature is no longer available, while the independent temperature probe demonstrates that the temperature is rising in the trailer. In this case, special events are also visible, such as a second rapid fuel loss within the customer's facility.

This invention may also be expanded to examine fuel usage for the entire cycle. The transport refrigeration unit's fuel level is shown for the same 30 hour period graphically.

The fuel usage for the transport delivery cycle clearly shows refueling, transport refrigeration unit use of fuel and fuel theft (rapid fuel loss) events. Initially, a refueling event of 47 gallons is recorded. Shortly afterwards, the refrigeration unit is turned on. Fuel use over the next period is shown consistently by wireless communications. A rapid fuel loss event of 25 gallons is recorded shown again by normal consumption by the transport refrigeration unit. The constant section at approximately 32 gallons illustrates when the refrigeration unit is turned off. A second rapid fuel loss event (20 gallons) is also shown.

All of these fuel events are overlay distinct operational events, which correspond to the use of fuel, such as the transport refrigeration on event, pre-cooling event, unloading event, etc.

Overall, the instantaneous wireless measurement of transport refrigeration activities, coupled with the use of fuel, provides freight operators information to improve their operations, save fuel, reduce maintenance costs and eliminate wasteful emissions. It also permits freight operators to enforce equipment use fees that are generally applied in the transport refrigeration industry. These use fees, called assessorial charges, involve a third party's use of the operators'equipment and/or fuel, and may involve reimbursement of operators' unexpected costs. For instance, should an transport refrigeration operator drop off a reefer trailer for unloading at a customer facility, they may create an expected time frame that the unit may stay in the staging area prior to unloading for that specific facility. Until this invention, the measurement of the dwell time in the staging area has been difficult to assess. This invention allows the operator to repeatedly measure specific operations, which may be applied to the assessorial portion of their contract. For instance, if a transport refrigeration unit uses one gallon per hour while on, the contractual agreement for the dwell time in a staging area is 8 hours, and the actual dwell time of the shipment is 10 hours, then the freight operator may seek re-imbursement for the additional two gallons of fuel (10 hours minus 8 hours×1 gallon/hour), as well as the cost that the transport equipment is not being utilized. Other reimbursement costs might be applied to fuel theft incidences, overcharges for refueling activities, and unauthorized use of the transport refrigeration unit. This invention makes the automatic application of assessorial charges for refrigerated operations automatic.

Wireless monitoring allows measuring each aspect of the delivery cycle. Thus, each segment of the delivery cycle is, according to an embodiment, stored in a database for each shipment. Over the course of several shipments, a standard time frame is developed for each operation. Therefore, in real-time, each subsequent shipment is compared to historical performance automatically, allowing the operator to assess in real time whether an operation is inconsistent with his standard operation. This leads to continuous measurable improvement of the operators operation, as well as allow the operator to make informed decisions regarding assessorial charges.

Because of the context of providing the operational unit's temperature profile, in comparison to other operational events (i.e. the pre-cooling condition was satisfied, the shipment arrived prior to opening the door, etc.), this invention helps the operator to prove, in real-time, that each shipment is compliant with its planned temperature. In this manner, these embodiments serve for immediate dispute resolution, eliminating the need for costly and uninformed negotiations after the fact. The embodiments eliminate the need for costly recording devices, which are cumbersome to use considering the logistical activities of each transport refrigeration unit after deliveries are made.

The wireless monitoring device, uniquely configured to measure refrigerated transport operations, collects a host of meaningful operational data specific to refrigerated transport delivery cycles. The wireless device is configured to interpret specific sensor readings, which are sometimes compared to historical readings, to interpret a specific event of a transport refrigeration delivery cycle. Because a wireless device can be uniquely configured to read all of these elements simultaneously, then the invention can be universally applied to all types of transport refrigeration delivery operations.

An embodiment of this invention involves the graphical display of each refrigerated transport cycle in its entirety. Another embodiment of this invention involves the repeated and summarized measurement of each part of the transport delivery operation.

This invention allows the transport refrigeration unit operator to measure and visualize specific activities uniquely identified in the transport refrigeration cycle. According to embodiments of the invention, individual operational elements are measured by each unit's performance against time. One example includes recording all of these specific events in wireless communications to allow the time period between specific events to be recorded, which involve transport refrigeration and can be systematically measured for improved delivery operations. According to various embodiments of the invention, the following time frames are measured for each transport cycle, and used as reference for each subsequent delivery transport cycle applied to the same operational aspects.
1. The time frame each distribution center takes from the time a reefer enters the yard until the refrigerated unit is switched on.
2. The time frame from turning the reefer on until it is loaded.
3. The time frame that the reefer is loaded until it leaves a distribution center.
4. The time frame between which a reefer is dropped off at a delivery center until it is switched off.
5. The time frame that a delivery center unloads a reefer and switches it off until they notify the transport refrigeration unit operator.
6. The time frame that a transport refrigeration unit is pre-cooled from ambient temperature to a specific set point temperature.
7. The time frame between the creation of a pre-cooling event until the transport refrigeration unit is loaded.
8. The time frame that a refrigerated transport unit is wastefully in operation while within a specific distribution facility or customer's facility, measuring gallons of fuel wasted and unwanted carbon emissions.

These time frames are summarized and measured for each operator, distribution center, route, or customer location, and compared to historical measurements. The historical measurements may be collectively used for continuous measurable improvement to improve the transport refrigeration delivery cycle.

Furthermore, unique measurable events and alarms permit the following measurements to occur:
1. The frequency of rapid fuel loss events in the possession of a specific driver
2. The frequency of rapid fuel loss events in the location of specific distribution centers.
3. The frequency of rapid fuel loss events occurring in specific customer locations.
4. The frequency of third party use of the transport refrigeration unit, and the use of fuel, for the purposes of inventory storage and unauthorized use of equipment.
5. The frequency that customers of transport refrigeration operators trigger assessorial costs for specific shipments or facilities.
6. The frequency that refrigerated trailers is loaded with lading that has not been pre-cooled.

One manner of automatically determining changes in the operations sensed is by differentiating the graphs of FIG. 2 and FIG. 3.

While embodiments of the invention have been described in detail, it will be evident to those skilled in the art that the invention may be embodied otherwise without departing from its spirit and scope.

What is claimed is:

1. A method, comprising:
continuously sensing the temperature of a load in a in a transport refrigerated unit;
wirelessly transmitting the sensed temperature to a network;
in said network determining changes temperature;
determining status of the load and the transport refrigeration unit on the basis of the temperatures and changes in temperatures
further determining the status of the load and the transport refrigeration unit on the basis of times between temperatures and between changes in temperatures.
